(19) United States
(12) Patent Application Publication
(10) Pub. No.: US 2011/0063940 A1
(43) Pub. Date: Mar. 17, 2011

(54) METHOD OF EXTRUDER OPERATION

(75) Inventor: Babu Padmanabhan, Bangalore (IN)

(73) Assignee: Steer Engineering Private Limited, Bangalore (IN)

(21) Appl. No.: 12/881,797

(22) Filed: Sep. 14, 2010

(30) Foreign Application Priority Data
Sep. 14, 2009 (IN) 2216/CHE/2009

(51) Int. Cl. B01F 7/00

(52) U.S. Cl. 366/82

(57) ABSTRACT

An extruder capable of improved mixing is disclosed. The extruder comprises of a housing having at least two cylindrical housing bores, each housing bore having an axis disposed parallel to the other axis. The extruder further comprises of at least a first screw shaft and a second screw shaft being disposed in the first and second housing bores. The first and second screw shaft being provided with extruder processing elements that defines a mixing zone. The first and second screw each having extruder D and a screw root diameter d. The first and second screw shaft each having a volumetric ratio of at least 1.4 wherein the volumetric ratio is defined by the extruder diameter D divided by the screw inner diameter d.

The invention relates to a system and method of mixing compounds. More particularly, the invention relates to a system and method of using elongational flow to achieve better mixing in an extrusion process.

### BACKGROUND

Twin screw extruders having a feed opening at one end and a discharge opening at the other end are well known and extensively used for specific purposes of mixing materials which includes kneading, homogenizing, distributing a material with or without increase in temperature or heat input in a continuous and controlled manner.

The material may consist of a single constituent or ingredient or multiple constituents in one phase or more phases. Some constituents may need to undergo phase transformation during processing. The work that is done by the extruder is the result of applications of forces that cause shearing action in various planes, compression, elongation and folding. It is desirable that these forces are applied uniformly on every particle or molecule only for a specific period of time in order to limit the work done as excessive work will cause fragile molecules to disintegrate resulting in a degraded product. The extent of work done is dependent on a number of factors including nature of the material being processed, amount of material that the extruder can receive as input at various ports, amount of torque available at any given speed, length of the extruder, and configuration of the extruder processing zone elements and components.

The volumetric ratio of an extruder is defined as the ratio of the extruder diameter [D] divided by the root diameter of the screw [d]. An increase in the volumetric ratio increases the fill capacity of the extruder though adversely affects the torque carrying capacity. The limitation on the torque restricts the types of materials that can be processed by the extruder, as some materials require higher torque. The specific torque [T/a³] of an extruder refers to the ratio between the torque [T] and the third power of the center distance between the two axes [a] of the twin screw extruder.

It is believed that an increase in shear rate enhances the quality of mixing and homogenization, though an increase in shear rate results in an increase in the specific energy requirements and temperatures. To balance this increase in the specific energy requirements and temperatures, it is essential to reduce the dwell time within the extruder and increase the through put. By way of example, to achieve a desired shear rate of 1000^{-ls} the prior art teaches that a volumetric ratio [D/d] of at least 1.5 and a speed of at least 800 rpm is required. However, the volumetric ratio [D/d] of at least 1.5 results in a reduced screw root diameter [d] and consequently limits the torque carrying capacity of the machine.

Mixing includes stretching and folding the processed material, with adequate stretching primarily responsible for good quality mixing. While both shear flow and elongational flow result in stretching of the material processed, excessive shearing action results in fragile molecules to disintegrate resulting in a degraded product.

### BRIEF DESCRIPTION OF ACCOMPANYING DRAWINGS

The accompanying drawings illustrate the preferred embodiments of the invention and together with the following detailed description serve to explain the principles of the invention.

FIG. 1 illustrates the geometry of a fractional lobe element formed from a single lobe and bi-lobe element.

FIG. 2 tabulates examples of fractional lobed mixing elements for use in accordance with an embodiment of the invention.

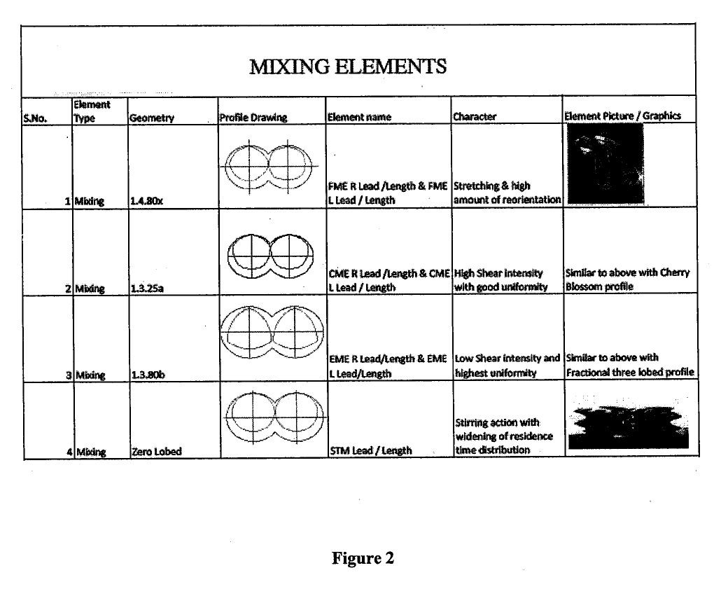

### SUMMARY

An extruder capable of improved mixing is disclosed. The extruder comprises of a housing having at least two cylindrical housing bores, each housing bore having an axis disposed parallel to the other axis. The extruder further comprises of at least a first screw shaft and a second screw shaft being disposed in the first and second housing bores. The first and second screw shaft being provided with extruder processing elements that defines a mixing zone. The first and second screw each having extruder D and a screw root diameter d. The first and second screw shaft each having a volumetric ratio of at least 1.4 wherein the volumetric ratio is defined by the extruder diameter D divided by the screw inner diameter d, the method comprising of mounting fractional lobed elements on the first and second screw shaft, and driving each of said first and second screw shafts at a speed of not more than 800 rpm, wherein a fractional lobed element is an element intermediate a first integer element (n) and a second integer element (N) by a predefined fraction, such that N/n is an integer and the fraction determines the degree of transition between the first integer and the second integer.

### DETAILED DESCRIPTION

The invention is directed towards a method of extruder operation providing improved mixing without limitations on torque. The invention is also directed towards an extruder capable of improved mixing without limitations on speed. The method of extruder operation includes the use of element design to increase the elongational or extensional flow and increase uniformity in application of forces on the material processed.

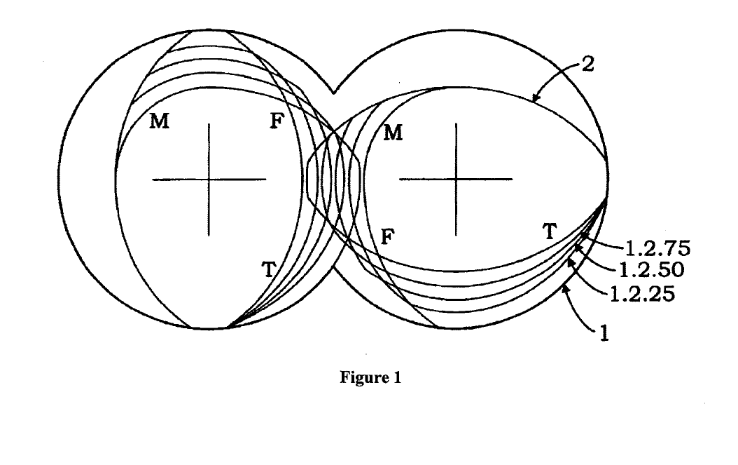

The extruder comprises a housing having at least two cylindrical housing bores, each housing bore having an axis disposed parallel to the other axis. A first screw shaft and a second screw shaft are disposed in the first and second housing bores respectively. Extruder processing elements are mounted on the first and second screw shaft and define a mixing zone within the extruder. The first and second screw each have extruder diameter D and a screw root diameter d such that the first and second screw shaft each has a volumetric ratio of at least 1.4 wherein the volumetric ratio is defined by the extruder diameter D divided by the screw inner diameter d. The increase in elongational flow is achieved by fractional lobed elements that are formed using two different integer lobes together. A fractional lobed element is an element intermediate a first integer element (n) and a second integer element (N) by a predefined fraction, such that N/n is an integer and the fraction determines the degree of transition between the first integer and the second integer. A single flight lobe and a bi-lobe can form fractional lobes such as 1.2.xx, where xx can be any number from 1 to 99. The numbers 1 to 99 define whether the fractional lobe will look more like a single flight element or a bi-lobed element. The numbers 1 and 2 in the notation 1.2.xx represent the lobe element intermediate a single flight element (1) and a bi-lobe element respectively (2). Examples of a fractional lobe element formed from a single lobe and a bi-lobe element are illustrated in FIG. 1.

A single flight element and a four lobe element can also form a fractional element designated by 1.4.xx, where xx could be any number from 1 to 99. Thus a fractional lobe element represented as 1.4.50 represents an element mid way between a single flight and a four lobe element. Similarly, a single lobe element and a tri-lobe element [1.3.xx] or a bi-lobe and a four lobe element [2.4.xx] may also be combined. These combinations result in a large number of fractional lobe elements.

The method of extruder operation comprises mounting such fractional lobed elements on the first and second screw shaft to define the extruder mixing zone, and driving each of said first and second screw shafts at a speed of not more than 800 rpm. The first and second screw shafts are preferably driven at a torque density of at least 8.5 Nm/cm³; the torque density defined by the shaft torque at each first and second shaft divided by the third power of the distance ‘a’ of the first and second axis.

### INDUSTRIAL APPLICABILITY

It is believed that elongational flow or extensional mixing rather than shear induced mixing results in better mixing of the processed material and converts the extruder into a mixing vessel that can operate at any desired speed independent of volume and torque. The fractional lobed elements increase the elongational flow and also provide uniformity in application of forces on the processed material. The use of fractional lobed elements in the manner described allows for a decrease in, speed of operation and therefore a decrease in the shear action.

Moreover, the use of fractional lobed elements in the manner described avoids the limitations of higher volumetric ratios and consequently limitations on torque. A lower volumetric ratio resulting in an increase in lobe number increases the contact between the lobes and the material processed, thereby increasing the work done and improving the quality of mixing.

We claim:

1. A method of extruder operation; the extruder comprising:
a housing having at least two cylindrical housing bores, each housing bore having an axis disposed parallel to the other axis,
at least a first screw shaft and a second screw shaft being disposed in the first and second housing bores; the first and second screw shaft being provided with extruder processing elements defining a mixing zone; the first and second screw each having extruder D and a screw root diameter d; the first and second screw shaft each having a volumetric ratio of at least 1.4 wherein the volumetric ratio is defined by the extruder diameter D divided by the screw inner diameter d,
the method comprising:
mounting fractional lobed elements on the first and second screw shaft, and driving each of said first and second screw shafts at a speed of not more than 800 rpm; wherein a fractional lobed element is an element intermediate a first integer element (n) and a second integer element (N) by a predefined fraction, such that N/n is an integer and the fraction determines the degree of transition between the first integer and the second integer.

2. A method of extruder operation as claimed in claim 1 comprising driving each of said first and second screw shafts at a torque density of at least 8.5 Nm/cm³; the torque density defined by the shaft torque at each first and second shaft divided by the third power of the distance ‘a’ of the first and second axis.

3. A method of extruder operation as claimed in claim 1 wherein the fraction may be any whole number between 1 and 99.

4. A method of extruder operation substantially as herein described with reference to and as illustrated by the accompanying drawings.
